(19) United States
(12) Patent Application Publication
(10) Pub. No.: US 2024/0361892 A1
(43) Pub. Date: Oct. 31, 2024

(54) DISPLAY METHOD AND DISPLAY APPARATUS FOR IMAGE-TEXT CONTENTS, STORAGE MEDIUM, AND COMPUTER PROGRAM PRODUCT

(71) Applicant: Lemon Inc., Grand Cayman (KY)

(72) Inventors: Linyi ZHENG, BEIJING (CN); Xiaotong MA, BEIJING (CN); Xinyu ZHANG, BEIJING (CN); Yujie LI, BEIJING (CN); Siqi TAN, CULVER CITY, CA (US); Qilin CHEN, CULVER CITY, CA (US)

(21) Appl. No.: 18/644,431

(22) Filed: Apr. 24, 2024

(30) Foreign Application Priority Data
Apr. 28, 2023 (CN) 202310484034.1

(51) Int. Cl. G06F 3/04845; G06F 3/0488

(52) U.S. Cl. CPC G06F 3/04845; G06F 3/0488; G06F 2203/04806

(57) ABSTRACT

The present disclosure relates to a display method and a display apparatus for image-text content, a storage medium, and a computer program product. The display method for image-text content includes: displaying image-text content in a feed, where the image-text content comprises an image and a truncated text; receiving an operation performed by a user on the image of the image-text content; and displaying a detail page of the image-text content in response to the operation performed by the user on the image of the image-text content being a specified operation, the detail page comprising the image and a full text.

### FIELD

The present disclosure generally relates to terminals, and in particular, to a display method and a display apparatus for image-text content, a storage medium, and a computer program product.

### BACKGROUND

In applications based on feeds, users can browse different media content typically comprising video or image-text (image and text) information through convenient switching operations. Image-text information uses text information, which is usually relatively short, to describe image(s) or other brief information that the publisher wants to present.

### SUMMARY

The following introduces a selection of concepts in a simplified form in order to provide a foundational understanding of some aspects of the present disclosure. The following is not an extensive overview of the disclosure, and is not intended to identify key or critical elements of the disclosure or to delineate the scope of the disclosure. The following merely presents some of the concepts of the disclosure as a prelude to the more detailed description provided thereafter.

Other features and advantages of the present disclosure will become apparent from the more detailed description given below. However, it should be understood that the following detailed description and specific examples, while indicating embodiments of the methods, and apparatus, are given by way of illustration only, since various changes and modifications within the spirit and scope of the concepts disclosed herein will become apparent to those skilled in the art from the following detailed description.

### BRIEF DESCRIPTION OF THE DRAWINGS

These and other objects, features, and characteristics of the present disclosure will become more apparent to those skilled in the art from a study of the detailed description that follows in conjunction with the appended claims and drawings, all of which form a part of this specification. In the drawings:

FIG. 1 shows a flowchart of an example information display method according to one or more embodiments of the present disclosure;

FIGS. 2A and 2B illustrate an example interface layout of a feed, according to one or more embodiments of the present disclosure;

FIG. 3A shows a schematic diagram of an example page of image-text content, according to one or more embodiments of the present disclosure;

FIG. 3B shows a schematic diagram of an example detail page of image-text content, according to one or more embodiments of the present disclosure;

FIG. 4 shows a flowchart of an example automatic playback control method, according to one or more embodiments of the present disclosure;

FIG. 5 shows a schematic structural diagram of an example display apparatus for image-text content, according to one or more embodiments of the present disclosure;

FIG. 6 shows a schematic structural diagram of an example display apparatus for image-text content, according to one or more other embodiments of the present disclosure; and

FIG. 7 shows a schematic structural diagram of an example display apparatus for image-text content, according to one or more other embodiments of the present disclosure.

The headings provided herein are for convenience only and do not necessarily affect the scope or meaning of what is claimed 5 in the present disclosure.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

Various examples and embodiments of the present disclosure will now be described. The following description provides specific details for a thorough understanding and enabling description of these examples. One of ordinary skill in the relevant art will understand, however, that one or more embodiments described herein may be practiced without many of these details. Likewise, one skilled in the relevant art will also understand that one or more embodiments of the present disclosure can include other features and/or functions not described in detail herein. All other embodiments obtained by persons of ordinary skill in the art based on the embodiments of the present disclosure without creative efforts shall fall within the protection scope of the present disclosure.

Unless otherwise specified, the relative arrangement, numerical expressions and numerical values of the components and steps set forth in these examples do not limit the scope of the disclosure.

At the same time, it should be understood that, for ease of description, the dimensions of the various parts shown in the drawings are not drawn to actual proportions.

Some well-known structures, functions, and/or techniques may not be shown or described in detail below, so as to avoid unnecessarily obscuring the relevant description. Where appropriate, these techniques, functions, and/or techniques should be considered as part of the disclosure.

Of all the examples shown and discussed herein, any specific value should be construed as merely illustrative and not as a limitation. Thus, other examples of exemplary embodiments may have different values.

It should be noted that like reference numerals and letters are used to denote like elements in the accompanying drawings, and therefore, once an element is defined in a drawing, there may not be a need for further discussion of that element in other accompanying drawings.

A feed (e.g., a social media feed) comprises a massive amount of media information, and users can switch between different media information by performing switching operations such as sliding up and down, scrolling, etc. Except for the switching process, users are typically presented with one piece of media content at a time to maximize the amount of information conveyed by each piece of media content.

Currently, media content in feeds and other applications tends to be short videos (e.g., videos having a duration less than a video length threshold, such as videos having a duration of less than 1 minute), image-text content with accompanying short text (e.g., text with a length less than a text length threshold), and there is less information consisting of mixed image(s) and long text (e.g., text having a length equal to or greater than a text length threshold). As a result, such applications can help users quickly obtain more diverse information and improve a range of information dissemination.

After analyzing relevant technologies, it was found that some users also have a need for more in-depth information gathering. Images with long text can well meet the needs of these users. However, feeds mainly present images and typically cannot accommodate a large amount of text.

On such basis, a technical problem to be actually solved in the present disclosure is how to present image-text content to facilitate users' efficient access to long text information.

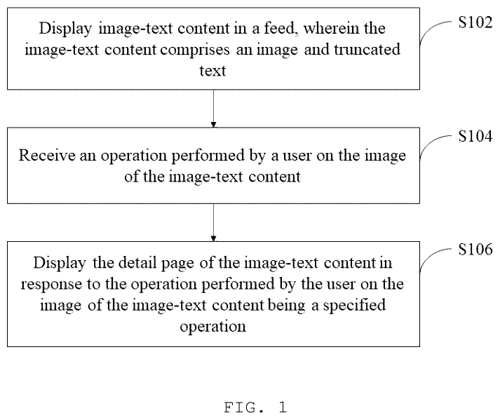

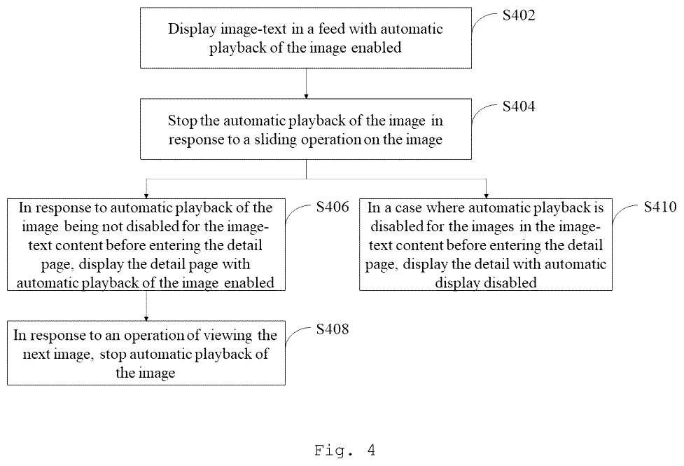

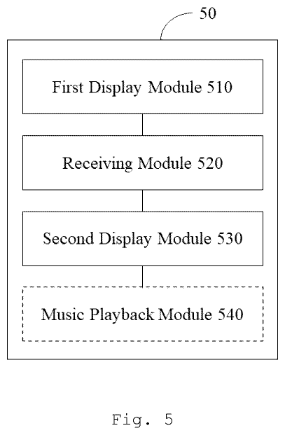

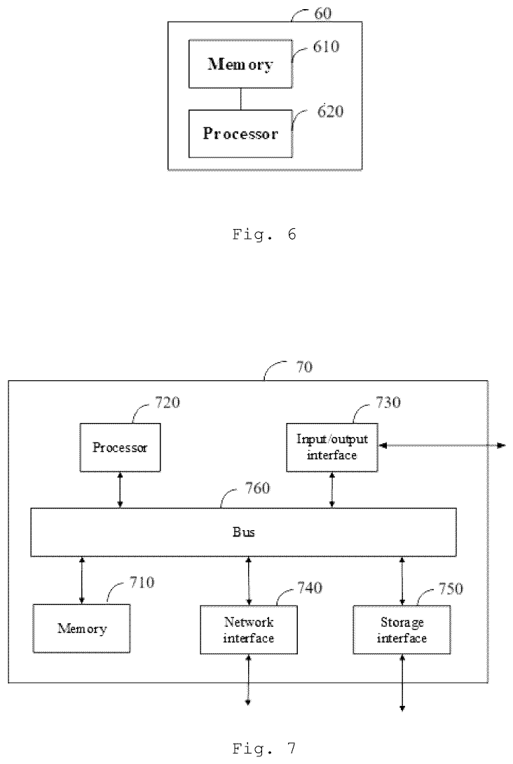

FIG. 1 illustrates an example information display method according to one or more embodiments of the present disclosure. The example information display method shown can be executed by a terminal, such as a mobile phone, tablet, personal computer, etc. For example, in an embodiment, one or more steps of the display method shown in FIG. 1 may be performed by one or more components of display apparatus 50 (shown in FIG. 5), display apparatus 60 (shown in FIG. 6), or display apparatus 70 (shown in FIG. 7). Each of display apparatus 50, 60, and 70 will be described in greater detail herein. As shown in FIG. 1, the example display method for image-text content comprises steps S102 to S104, in an embodiment.

In step S102, image-text content is displayed in a feed. In an embodiment, the image-text content displayed in the feed may comprise an image and truncated text. For example, the image-text content is content that comprises both an image and text, but full information of the image-text content is too long to display in its entirety on the feed page. Therefore, the text portion of the image-text content is displayed in a truncated form as truncated text.

In another example, the image-text content may comprise one or more images. In some embodiments, in a case where the image-text content comprises multiple images, the multiple images of the image-text content are displayed one by one in the feed, such as by automatic playback of the images or by switching and displaying the images in response to user actions (e.g., sliding, tapping, double tapping, long pressing, tapping the button, etc.).

In some embodiments, an aspect ratio of the image (e.g., the ratio of the image could be 4:3, 16:9, or square 1:1) in the image-text content is less than a first ratio threshold (e.g., 4:3). For example, images with an aspect ratio less than the first ratio threshold can be cropped and displayed so that the cropped images have an aspect ratio equal to the first ratio threshold. Thus, the consistency of the display of the images in the feed can be improved.

In some embodiments, in the feed, an image container used to carry the image of the image-text content has an aspect ratio equal to the first ratio threshold, and the image in the image container is displayed after adaptive scaling. In an example, after scaling, the top and bottom sides of the image reach the top and bottom sides of the image container, and/or the left and right sides of the image reach the left and right sides of the image container, to automatically achieve maximum display of the image in the image container, so that a larger image is displayed to the user as much as possible within a given layout. In some embodiments, the image is centered in the image container.

In some embodiments, the image of the image-text content is positioned in the image container, and the image container is arranged as a sticky element on the upper side of an interface of the feed. This top-sticky arrangement means that the upper side of the image container reaches the upper side of the interface. In this way, the screen space of a user device can be fully utilized.

In some embodiments, in a case where there are other controls displayed near the top of the interface of the feed in addition to the image container, such other controls may float over or overlay the image container to prevent the display of the image from being interfered with by the controls.

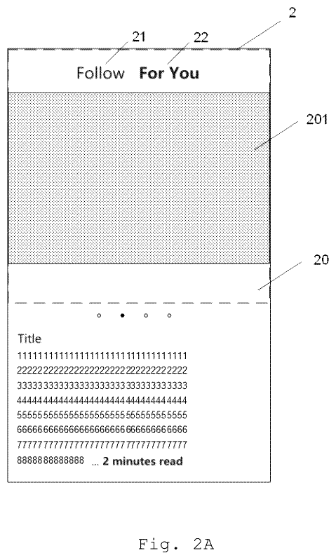

An image container displayed in a top-sticky manner can, in some cases, achieve a “full screen” effect on a portion of the interface of the feed. FIGS. 2A and 2B illustrate example effects of images displayed at different ratios.

In FIGS. 2A and 2B, a feed interface 2 comprises an image container 20, which is arranged in a top-sticky manner in the interface 2, in an embodiment. In addition, a “Follow” control 21 and a “For You” control 22 are also included in the interface 2. Certain image-text content comprises images 201 (as shown in FIG. 2A) and 202 (as shown in FIG. 2B), both of which are adaptively displayed in the image container 20.

As shown in FIG. 2B, an aspect ratio of the image 202 is substantially the same as that of the image container 20, or the image 202 is cropped because the original version of image 202 has an aspect ratio greater than that of the image container 20, and the cropped image 202 has an aspect ratio substantially the same as that of the image container 20. In this case, the image container 202 as well as the upper half of the interface 2 is filled with the image 202. Since the image container 20 is displayed in a top-sticky manner, the image 202 is also displayed in a top-sticky manner. The “Follow” control 21 and the “For You” control 22 are floated over the image 202, in an embodiment. This creates a “full screen” effect in the top half of the interface 2, maximizing the use of the interface space and increasing the amount of information presented to the user.

In some embodiments, the truncated text of the image-text content is in a text container in a preview interface (e.g., the interface of the feed). The image container (e.g., image container 20) is positioned above the text container and may be overlapped by the text container, in an embodiment. For example, the center of the image container may be positioned higher within the interface of the feed than the center of the text container. In some cases (e.g., where the image of the image-text content is larger in size than the truncated text of the image-text content and takes up most of the space in the interface of the feed), the truncated text may visually float over the image displayed within the interface.

For information that comprises long text, displaying all of the text in a feed directly has a significant impact on the layout and interaction of the feed. Therefore, for information comprising long text, only the image-text content comprising image(s) and truncated text is displayed in the feed, in an embodiment. In a case where a user is interested in such image-text content, a detail page can be displayed for further access to the full text of the long text.

The truncated text in the image-text content refers to a text obtained by deleting or hiding part of the full text, and may be marked with an identifier of the truncated text, in one or more embodiments. In an example, the truncated text may be a portion of the full text starting from the beginning of the full text, with the remaining text after the portion being deleted. In another example, the truncated text may be one or more segments of text automatically extracted from the full text by natural language processing algorithms. In an embodiment, a length of the truncated text is determined based on a target length threshold (e.g., fifty word, four lines of text, two-hundred characters, any combination thereof, or various other threshold amounts), which can be measured in words, lines, characters, and so on.

In some embodiments, the truncated text comprises a text of a target length and the identifier of the truncated text. This allows users to be prompted to view the detail page when there is only limited display space for the text in image-text content.

In an embodiment, the identifier of the truncated text may be formatted differently from other text content (e.g., different bold, font, color, background, etc.) to facilitate discrimination by users. The text of a target length and the identifier of the truncated text can also be concatenated by a symbol such as, for example, “ . . . ”, or the identifier of the truncated text can be placed in parentheses.

In some embodiments, the identifier of the truncated text represents at least one of a prompt to view details, a length of a text in the full text other than the truncated text, or a reading time of the text in the full text other than the truncated text.

In one example, the prompt to view details may be a prompt such as “more” or “see more” to indicate that there is more content that has been omitted from the display, or “long text” to indicate an attribute of the image-text content to prompt users to view a further detail page.

The length of a text in the full text other than the truncated text refers to the length of the remaining text that is not displayed, which can be counted in words, lines, characters, etc. For example, in a case where a text of certain image-text content is 1500 words in total, and the truncated text contains 150 words, there are still 1350 words omitted from the display. In such an example, the identifier of the truncated text may be “1350 words”. This allows the length of the remaining text to be accurately quantified.

The reading time of the text in the full text other than the truncated text refers to the time required to read the remaining text that is not displayed, and indicates how much additional time it takes users to read the full text. In an embodiment, this reading time of the text in the full text other than the truncated text can be an average reading time of the audience, for example, the reading time of the text in the full text other than the truncated text can be determined from a correspondence between numbers of words and reading times in existing statistical data. For example, if existing statistical data indicates that, on average, 120 words take 40 seconds to read and 360 words are omitted, the identifier of the truncated text could be, for example, “2 minutes read” or “2 minutes left to read”. This makes it possible to visualize the rest of the information in terms of time.

It should be understood by those skilled in the art that other types of identifiers of the truncated text may be used in addition to or instead of the example identifiers discussed above, depending on, for example, various factors associated with the users, the platform, and the like.

In some embodiments, the target length of the truncated text is determined based on the aspect ratio of the image in the image-text content. In a case where the aspect ratio of the image allows more space to be available in the current interface, the target length of the truncated text can be increased accordingly. Thus, the length of the displayed text constituting the truncated text can be adaptively determined based on the aspect ratio of the image.

In some embodiments, the target length of the truncated text is a first length in response to an aspect ratio of at least one image of the image-text content being greater than a second ratio threshold; and the target length of the truncated text is a second length that is no greater than the first length in response to the aspect ratio of the at least one image of the image-text content being not greater than the second ratio threshold.

In some embodiments, the feed also comprises video content comprising a video and a text of the video. In this way, the media types of the feed are enriched. The text of the video is displayed in full or truncated, for example, in a case where a text exceeds a video text length threshold (e.g., fifty word, four lines of text, two-hundred characters, any combination thereof, or various other threshold amounts), truncated text is displayed by default, in an embodiment. The full text of the video is displayed after a user triggers an interactive control to display the full content.

In some embodiments, in a case where an aspect ratio of at least one image of the image-text content is greater than the second ratio threshold, the length of the truncated text of the image-text content is greater than the length of the truncated text in the video content. Images with a larger aspect ratio take up less space in the height direction of the interface of the feed, allowing more text content to be displayed in the interface clearly. In this case, it is possible to display more text of the image-text content than text of the video content. For example, the text of image-text content in a feed can be displayed in up to 8 lines, while the text of video content is displayed in 4 lines by default, in an embodiment. It is thus possible to differentiate between different types of content while improving the efficiency of information delivery.

In some embodiments, the second ratio threshold is greater than the first ratio threshold.

Referring back to the example method shown in FIG. 1, in step S104, an operation performed by a user on the image of the image-text content is received.

In step S106, the detail page of the image-text content is displayed in response to the operation performed by the user on the image of the image-text content being a specified operation. In an embodiment, the detail page comprises the image and a full text of the image-text content.

In a case where a user performs a specified operation on the image in the image-text content, the user may be interested in the image-text content. Therefore, the display of the detail page can be triggered by the specified operation, in an embodiment. In addition, the large coverage area of the image also makes operation more convenient for users. The specified operation can comprise one or more types of operations.

In some embodiments, the specified operation is an operation commonly used for viewing images, such as an operation for switching between images or scaling images. Some specific operations will be described below as examples.

In some embodiments, the specified operation comprises a sliding operation. In some embodiments, the sliding operation has at least one of a target direction or a target distance. For example, in applications where images are switched by horizontal sliding, the sliding operation can also be horizontal sliding. The ‘horizontal’ sliding may not be absolute, for example, if an angle between the sliding direction and the horizontal direction is within a target range, the sliding direction can be considered as the ‘horizontal direction’. The target distance, which can also be a range, can refer to a distance specified for other sliding operations, or can refer to a sliding distance specified separately.

In some embodiments, the sliding operation of the specified operation has different sliding information from a sliding operation for switching between different content in a feed, the sliding information comprising at least one of sliding direction and sliding distance. Thus, the sliding operation of the specified operation can be distinguished from the operation for content switching.

A sliding operation is usually used to switch between images. When a user wants to view images other than a currently displayed image in the image-text content, the user indicates that the user may be interested in the image-text content, and therefore the display of the detail page can be triggered, in an embodiment.

In some embodiments, the action range of the sliding operation is an area covered by the currently displayed image or the image container. The action range refers, for example, to a touch range during the execution of the sliding operation, or a starting touch point of the sliding operation, etc. Other settings can be made as needed by those skilled in the art which will not be repeated here.

In some embodiments, the sliding operation is a sliding operation on any image. This can improve the convenience of accessing the detail page.

In some embodiments, the sliding operation is a sliding operation on the last image of the plurality of images, and a sliding operation on images other than the last image does not trigger the display of the detail page, but rather performs the operation of switching to the display of an adjacent image. Thus, when it is confirmed that the user has received more information about the image-text content, e.g., when a high level of interest has been generated, the display of the detail page is triggered.

Considering that sliding is a relatively high-frequency operation, in order to reduce the probability of misoperation, when the user enters the detail page by sliding, the first sliding after returning to the feed no longer triggers the display of the detail page, in an embodiment. In some embodiments, the image-text content is displayed in the feed in response to a return operation performed by the user on the detail page; and before the user switches to content other than the image-text content in the feed, where the detail page is not displayed in response to another sliding operation performed by the user on the image. That is, no feedback is provided for this operation, or a feedback of switching to an adjacent image is provided. The detail page can be re-accessed in another way as needed. In addition, if the user switches to another content in the feed and then switches back to that image-text content, the display of the detail page can be re-triggered by a sliding operation.

For example, when image-text content A is displayed in a feed, the user can slide on an image of image-text content A to enter its detail page. When the user performs a return operation on the detail page of image-text content A and returns to image-text content A in the feed, if the user does not switch to a previous content B or a next content C of image-text content A, the detail page of A cannot be accessed when the user performs a further sliding operation on an image of image-text content A. In this situation, the sliding operation can be used for image switching, for example. If the user switches to previous content B or next content C, a detail page of content B or C can be accessed by a sliding operation. When the user switches back to content A from content B or C, if the user performs another sliding operation on an image of content A, the detail page of content A will be displayed. This reduces the probability of misoperation by users who have already read the detail page or have little interest in the content.

This method of triggering the display of the detail page by the sliding operation is relatively simple and easy for users to operate, thus improving the interactivity of the image-text content.

In some embodiments, the specified operation performed by the user on the image of the image-text content comprises a scaling operation. When a user wants to upscale an image, the user indicates that the user is interested in the content. An upscaling operation is usually accompanied by a downscaling operation, or a downscaling operation may be performed due to improper operation when the user wants an upscaling operation. Therefore, the downscaling operation may indirectly reflect the user's interest.

The following is an example description of the two scaling detection processes.

In some embodiments, a user first touches a screen with his two fingers, then zooms in on an image with a pinch out gesture, and finally triggers the display of the detail page when the user stops touching the screen.

In some embodiments, a user first touches a screen with his two fingers, zooms in on an image with a pinch out gesture, followed by a pinch in gesture to zoom out from the image, and then triggers the display of the detail page when the user stops touching the screen.

That is, after detecting the user's scaling operation, the display of the detail page can be triggered when the user stops touching the screen.

The frequency of triggering the display of the detail page with zoom in and out operation is relatively low, resulting in a lower probability of misoperation by users, thus improving the interactivity of the image-text content.

In some embodiments, the specified operation performed by the user on the image of the image-text content comprises a click operation. For example, if a user clicks on any image in the image-text content, the detail page of image-text content can be accessed.

This method of triggering the display of the detail page through a click operation is more intuitive and easy for users to understand and operate, thus improving the interactivity of the image-text content.

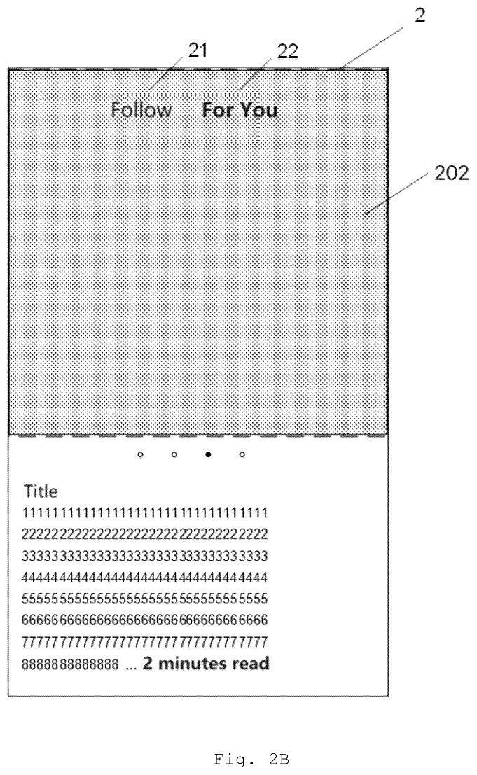

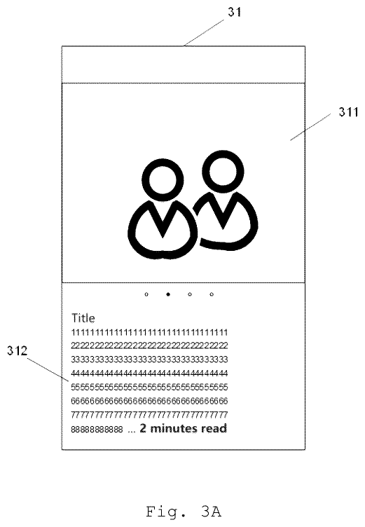

FIGS. 3A and 3B show schematic diagrams of an example page of image-text content and its associated detail page. In FIG. 3A, a page 31 of image-text content comprises an image container 311 and a text container 312. In the example shown, the image container 311 comprises four images, with the second image currently displayed; and the text container 312 comprises a truncated text and an identifier “2 minutes read” of the truncated text. When a user performs a specific operation on the image, a detail page 32 shown in FIG. 3B is displayed. In the detail page 32, the image container 321 comprises 4 images, with the second image currently displayed; and the text container 322 comprises a full text.

The above embodiment implements a scheme for providing a user with image-text content in a feed, where the truncated text is displayed in the feed and a detail page containing full text is displayed in response to the user's specified operation. Thus, if the user is interested in the image-text content while browsing the feed, he/she can further explore the complete information of the image-text content through a convenient and easy-to-understand operation, to conveniently and efficiently obtain long text information. Furthermore, in the above embodiment, the type of content in the feed can be expanded with minimal impact on the global architecture of the feed.

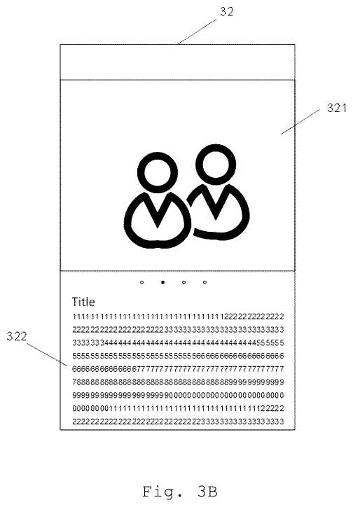

In some embodiments, images of the image-text content can be played automatically one after another, whether on a page with the truncated text of the image-text content or on its corresponding detail page. In an embodiment, some image-text content can also have background music. Some embodiments of the present disclosure can control the automatic playback of images based on user operations. An embodiment of an automatic playback control method for images will be described herein with reference to FIG. 4.

FIG. 4 shows a flowchart of an example automatic playback control method according to one or more embodiments of the present disclosure. As shown in FIG. 4, the automatic playback control method of this embodiment comprises steps S402 to S404. For example, in an embodiment, one or more steps of the automatic playback control method shown in FIG. 4 may be performed by one or more components of display apparatus 50 (shown in FIG. 5), display apparatus 60 (shown in FIG. 6), or display apparatus 70 (shown in FIG. 7). Each of display apparatus 50, 60, and 70 will be described in greater detail herein.

In step S402, image-text content is displayed in a feed with automatic playback of the image enabled.

In step S404, the automatic playback of the image is stopped in response to a sliding operation on the image. In another embodiment, the automatic playback of the image is stopped in response to another specified operation other than a sliding operation, such as, for example, tapping on the image.

In an embodiment, the images will continue to play back automatically if the user does not perform a sliding operation or other operation to stop the automatic playback of the images.

When the detail page is displayed, whether to continue automatic playback of the image is determined based on a final Autoplay (automatic playback) state of the image-text content before entering the detail page, in accordance with an embodiment. The Autoplay state indicates whether automatic playback of the image is enabled. That is, an automatic playback state of the image in the detail page is the same as a last automatic playback state of the image before entering the detail page.

In an embodiment, the automatic playback control method shown in FIG. 4 may further comprise step S406 and/or step S408.

In step S406, in response to automatic playback of the image being not disabled (e.g., remaining enabled) for the image-text content before entering the detail page, the detail page is displayed with automatic playback of the image enabled.

In step S408, in response to an operation of viewing the next image, automatic playback of the image is stopped.

In an embodiment, automatic playback of the image continues in a case where the user does not perform an operation to view the next image or another operation for stopping automatic playback.

In an embodiment, the automatic playback control method shown in FIG. 4 may further comprise step S410.

In step S410, in a case where automatic playback is disabled for the images in the image-text content before entering the detail page, the detail page is displayed with automatic display disabled.

For example, when returning to the interface of the feed displaying the image-text content from the detail page, the state of automatic playback is the same as on the detail page.

In some embodiments, the playback of background music continues when automatic image playback is stopped in the detail page of the image-text content. Thus, the playback of music continues regardless of whether automatic image playback is stopped or not.

With the above automatic playback control scheme, it is possible to maintain the consistency of automatic playback between the feed page and the detail page.

An embodiment of a display apparatus for image-text content of the present disclosure will be described below with reference to FIG. 5.

FIG. 5 shows a schematic structural diagram of an example display apparatus for image-text content according to one or more embodiments of the present disclosure. As shown in FIG. 5, the display apparatus 50 includes a first display module 510 configured to display image-text content in a feed, where the image-text content comprises an image and a truncated text; a receiving module 520 configured to receive an operation performed by a user on the image of the image-text content; and a second display module 530 configured to display a detail page of the image-text content in response to the operation performed by the user on the image of the image-text content being a specified operation, where the detail page includes the image and a full text.

In some embodiments, the specified operation comprises a sliding operation.

In some embodiments, the sliding operation of the specified operation has different sliding information from a sliding operation for switching between different content in the feed, where the sliding information includes at least one of a sliding direction and a sliding distance.

In some embodiments, the image-text content includes a plurality of images, and the second display module 530 is further configured to display the detail page of the image-text content in response to the sliding operation performed by the user on any one of the plurality of images.

In some embodiments, the image-text content includes a plurality of images, and the second display module 530 is further configured to display the detail page of the image-text content in response to the sliding operation performed by the user on a last image among the plurality of images, where a sliding operation performed by the user on an image other than the last image among the plurality of images is used to switch to a display of an adjacent image of the other image.

In some embodiments, the first display module 510 is further configured to display the image-text content in the feed in response to a return operation performed by the user on the detail page, where before the user switches to content other than the image-text content in the feed, the detail page is not displayed in response to another sliding operation performed by the user on the image.

In some embodiments, the specified operation comprises a scaling operation.

In some embodiments, the specified operation comprises a click operation.

In some embodiments, the first display module 510 is further configured to, in a case where an automatic playback of the image is enabled in the feed, stop the automatic playback of the image in response to a sliding operation on the image.

In some embodiments, an automatic playback state of the image in the detail page is same as a last automatic playback state of the image before entering the detail page.

In some embodiments, the second display module 530 is further configured to, in a case where an automatic playback of the image is enabled in the detail page, stop the automatic playback of the image in response to a sliding operation on the image.

In some embodiments, the image-text content further comprises background music, and the display apparatus 50 further comprises: a music playback module 540 configured to continue playing the background music in response to stopping automatic image playback in the detail page of the image-text content.

In some embodiments, an aspect ratio of the image in the image-text content is less than a first ratio threshold (e.g., 4:3).

In some embodiments, the image container for carrying the images is arranged as a sticky element on an upper side of an interface of the feed.

In some embodiments, the truncated text comprises a text of a target length and an identifier of the truncation text, where the identifier represents at least one of a prompt to view details, a length of a text in the full text other than the truncated text, or a reading time of the text in the full text other than the truncated text.

In some embodiments, the target length is determined from an aspect ratio of the image.

In some embodiments, the target length is a first length in response to an aspect ratio of at least one image of the image-text content is greater than a second ratio threshold; and the target length is a second length that is no greater than the first length in response to the aspect ratio of the at least one image of the image-text content is not greater than the second ratio threshold.

FIG. 6 shows a schematic structural diagram of an example display apparatus for image-text content according to one or more other embodiments of the present disclosure. As shown in FIG. 6, a display apparatus 60 for image-text content of this embodiment includes a memory 610 and a processor 620 coupled to the memory 610. The processor 620 is configured to, based on instructions stored in the memory 610, carry out a display method for image-text content according to any one of the above embodiments.

The memory 610 may comprise, for example, system memory, a fixed non-volatile storage medium, or the like. The system memory stores, for example, an operating system, application programs, a boot loader, and other programs.

FIG. 7 shows a schematic structural diagram of an example display apparatus for image-text content according to one or more other embodiments of the present disclosure. As shown in FIG. 7, a display apparatus 70 for image-text content of this embodiment includes a memory 710 and a processor 720, and may further include an input-output interface 730, a network interface 740, a storage interface 750, and the like. These interfaces 730, 740, 750, the memory 710 and the processor 720 may be connected through a bus 770, for example. The input-output interface 730 provides connection interface for input-output devices such as a display, a mouse, a keyboard, and a touch screen. The network interface 740 provides a connection interface for various networked devices. The storage interface 750 provides a connection interface for external storage devices such as an SD card and a USB flash disk.

An embodiment of the present disclosure further provides a computer-readable storage medium on which a computer program is stored, characterized in that the program when executed by a processor implements any one of the above display methods for image-text content.

According to a first aspect of some embodiments of the present disclosure, there is provided a display method for image-text content, comprising: displaying image-text content in a feed, wherein the image-text content comprises an image and a truncated text, and the truncated text is a shortened version of a full text of the image-text content; receiving an operation performed by a user on the image of the image-text content; and displaying a detail page of the image-text content in response to the operation performed by the user on the image of the image-text content being a specified operation, the detail page comprising the image and a full text.

In some embodiments, the specified operation comprises a sliding operation.

In some embodiments, the sliding operation of the specified operation has different sliding information from a sliding operation for switching between different content in the feed, the sliding information comprising at least one of a sliding direction or a sliding distance.

In some embodiments, the image-text content comprises a plurality of images, and the displaying the detail page of the image-text content in response to the operation performed by the user on the image of the image-text content being the specified operation comprises: displaying the detail page of the image-text content in response to the sliding operation performed by the user on any one of the plurality of images.

In some embodiments, the image-text content comprises a plurality of images, and the displaying the detail page of the image-text content in response to the operation performed by the user on the image of the image-text content being the specified operation comprises: displaying the detail page of the image-text content in response to the sliding operation performed by the user on a last image among the plurality of images, wherein a sliding operation performed by the user on other image than the last image among the plurality of images is used to switch to a display of an adjacent image of the other image.

In some embodiments, the display method further comprises: displaying the image-text content in the feed in response to a return operation performed by the user on the detail page; and before the user switches to content other than the image-text content in the feed, not displaying the detail page in response to another sliding operation performed by the user on the image.

In some embodiments, the specified operation comprises a scaling operation.

In some embodiments, the specified operation comprises a click operation.

In some embodiments, the displaying the image-text content in the feed comprises: in a case where an automatic playback of the image is enabled in the feed, stopping the automatic playback of the image in response to a sliding operation on the image.

In some embodiments, an automatic playback state of the image in the detail page is same as a last automatic playback state of the image before entering the detail page.

In some embodiments, the displaying the detail page of the image-text content comprises: in a case where an automatic playback of the image is enabled in the detail page, stopping the automatic playback of the image in response to a sliding operation on the image.

In some embodiments, the image-text content further comprises background music, and the display method further comprises: continuing playing the background music in response to stopping automatic image playback in the detail page of the image-text content.

In some embodiments, an aspect ratio of the image in the image-text content is less than a first ratio threshold.

In some embodiments, an image in the image-text content having an aspect ratio greater than the first ratio threshold is cropped based on the first ratio threshold and then displayed.

In some embodiments, an image container used to carry the image has an aspect ratio equal to the first ratio threshold, and the image in the image container is displayed after adaptive scaling.

In some embodiments, the image container for carrying the images is arranged as a sticky element on an upper side of an interface of the feed.

In some embodiments, the truncated text comprises a text of a target length and an identifier of the truncated text, wherein the identifier represents at least one of a prompt to view details, a length of a text in the full text other than the truncated text, or a reading time of the text in the full text other than the truncated text.

In some embodiments, the target length is determined from an aspect ratio of the image.

In some embodiments, the target length is a first length in response to an aspect ratio of at least one image of the image-text content is greater than a second ratio threshold; and the target length is a second length that is no greater than the first length in response to the aspect ratio of the at least one image of the image-text content is not greater than the second ratio threshold.

According to a second aspect of some embodiments of the present disclosure, there is provided a display apparatus for image-text content, comprising: a memory; and a processor coupled to the memory, the processor configured to, based on instructions stored in the memory, carry out any one of the foregoing display methods for image-text content.

According to a third aspect of some embodiments of the present disclosure, there is provided a computer-readable storage medium on which a computer program is stored, wherein the program when executed by a processor carries out any one of the foregoing display methods for image-text content.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture including instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

The above is merely preferred d embodiments of this disclosure, and is not limitation to this disclosure. Within spirit and principles of this disclosure, any modification, replacement, improvement and etc. shall be contained in the protection scope of this disclosure.

What is claimed is:

1. A display method for image-text content, comprising:
displaying image-text content in a feed, wherein the image-text content comprises an image and a truncated text, and the truncated text is a shortened version of a full text of the image-text content;
receiving an operation performed by a user on the image of the image-text content displayed in the feed; and
displaying a detail page of the image-text content in response to the operation performed by the user on the image of the image-text content being a specified operation, the detail page comprising the image and the full text of the image-text content.

2. The display method according to claim 1, wherein the specified operation comprises a sliding operation.

3. The display method according to claim 2, wherein the sliding operation of the specified operation has different sliding information from a sliding operation for switching between different content in the feed, the sliding information comprising at least one of a sliding direction and a sliding distance.

4. The display method according to claim 2, wherein the image-text content comprises a plurality of images, and the displaying the detail page of the image-text content in response to the operation performed by the user on the image of the image-text content being the specified operation comprises:
displaying the detail page of the image-text content in response to the sliding operation performed by the user on any one of the plurality of images.

5. The display method according to claim 2, wherein the image-text content comprises a plurality of images, and the displaying the detail page of the image-text content in response to the operation performed by the user on the image of the image-text content being the specified operation comprises:
displaying the detail page of the image-text content in response to the sliding operation performed by the user on a last image among the plurality of images, wherein a sliding operation performed by the user on an image other than the last image among the plurality of images is used to switch to a display of an adjacent image of the other image.

6. The display method according to claim 2, further comprising:
displaying the image-text content in the feed in response to a return operation performed by the user on the detail page; and
before the user switches to content other than the image-text content in the feed, not displaying the detail page in response to another sliding operation performed by the user on the image.

7. The display method according to claim 1, wherein the specified operation comprises a scaling operation.

8. The display method according to claim 1, wherein the specified operation comprises a click operation.

9. The display method according to claim 1, wherein the displaying the image-text content in the feed comprises:
in a case where an automatic playback of the image is enabled in the feed, stopping the automatic playback of the image in response to a sliding operation performed by the user on the image.

10. The display method according to claim 1, wherein an automatic playback state of the image in the detail page is the same as a last automatic playback state of the image before entering the detail page.

11. The display method according to claim 10, wherein the displaying the detail page of the image-text content comprises:
in a case where an automatic playback of the image is enabled in the detail page, stopping the automatic playback of the image in response to a sliding operation performed by the user on the image.

12. The display method according to claim 11, wherein the image-text content further comprises background music, the method further comprising:
continuing playing the background music in response to stopping the automatic playback of the image in the detail page of the image-text content.

13. The display method according to claim 1, wherein an aspect ratio of the image in the image-text content is less than a ratio threshold.

14. The display method according to claim 13, wherein an image in the image-text content having an aspect ratio greater than the ratio threshold is cropped based on the ratio threshold and then displayed.

15. The display method according to claim 13, wherein an image container used to carry the image has an aspect ratio equal to the ratio threshold, and the image in the image container is displayed after performing adaptive scaling on the image.

16. The display method according to claim 1, wherein an image container used to carry the image is arranged as a sticky element on an upper side of an interface of the feed.

17. The display method according to claim 1, wherein the truncated text comprises a text of a target length and an identifier of the truncated text, wherein the identifier represents at least one of a prompt to view details of the truncated text, a length of a text in the full text other than the truncated text, or a reading time of the text in the full text other than the truncated text.

18. The display method according to claim 17, wherein the target length is determined from an aspect ratio of the image.

19. The display method according to claim 18, wherein:
the target length is a first length in response to an aspect ratio of at least one image of the image-text content being greater than a ratio threshold; and
the target length is a second length that is no greater than the first length in response to the aspect ratio of the at least one image of the image-text content being not greater than the ratio threshold.

20. A display apparatus for image-text content, comprising:
a memory storing instructions thereon; and
a processor coupled to the memory, the processor configured to execute the instructions stored in the memory and perform operations comprising:
displaying image-text content in a feed, wherein the image-text content comprises an image and a truncated text, and the truncated text is a shortened version of a full text of the image-text content;
receiving an operation performed by a user on the image of the image-text content displayed in the feed; and
displaying a detail page of the image-text content in response to the operation performed by the user on the image of the image-text content a specified operation, the detail page comprising the image and the full text of the image-text content.

21. A non-transitory computer-readable storage medium storing instructions that, when executed by one or more processors, causes the one or more processors to perform operations comprising:
displaying image-text content in a feed, wherein the image-text content comprises an image and a truncated text, and the truncated text is a shortened version of a full text of the image-text content;
receiving an operation performed by a user on the image of the image-text content displayed in the feed; and
displaying a detail page of the image-text content in response to the operation performed by the user on the image of the image-text content being a specified operation, the detail page comprising the image and the full text of the image-text content.
